(19) United States
(12) Patent Application Publication
(10) Pub. No.: US 2003/0224783 A1
(43) Pub. Date: Dec. 4, 2003

(54) System for providing displays in an outdoors retail area of a retail store

(76) Inventor: Gregory Marshall Ruddell, El Dorado Hills, CA (US)

Correspondence Address: SIERRA PATENT GROUP, LTD., P O BOX 6149, STATELINE, NV, 89449, US

(21) Appl. No.: 10/434,808

(22) Filed: May 8, 2003

Related U.S. Application Data
(60) Provisional application No. 60/379,215, filed on May 8, 2002.
(60) Provisional application No. 60/407,498, filed on Aug. 30, 2002.

(51) Int. Cl. H04H 7/00; H04B 1/40

(52) U.S. Cl. 455/426.2; 455/3.06; 455/74

(57) ABSTRACT

A system for providing displays to consumers in an outdoor retail area of a retail store. The system includes an antenna for receiving signals. A control unit connected is communicatively coupled to the antenna to receive the signals and to generate display signals from the signals. A display is mounted proximate a retail station. The display receives the display signals from the control unit and provides a display to consumers. A display communications path communicatively couples the display to the control unit. The display communications path is external to a retail communications path connecting a retail station in the outdoor area to the retail store.

### RELATED APPLICATIONS

This application hereby claims priority to provisional applications 60/379,215 filed on May 8, 2002, and 60/407,498 filed on Aug. 30, 2002. The above-identified provisional applications are hereby expressly incorporated by reference into this application.

### FIELD OF THE INVENTION

This invention relates to a system for providing an electronic display in an outdoor retail area proximate a retail store. More particularly, this invention relates to a system that provides monitors in an outdoor area that are connected to a control unit via a communications path that is external to and independent from communications path connecting retail systems to other systems inside the retail store.

Problem

In today's market place, retailers are continuously searching for more effective ways to reach and influence consumers with advertisements and promotions. Outdoor advertising is highly desirable because it reaches mobile consumers when they are at or near retail establishments and more likely to make a purchasing decision based upon the advertisement or promotion. One manner in which the advertisements and promotions are presented is via a video and/or audio broadcast. One particular method is to have a monitor and audio speakers near a point of sale. The monitor provides video programming and the audio speakers provide an audio track for the video programming. The programming may be a news or entertainment show broadcast with promotions or advertisements inserted into the programming as commercials.

In order to provide the broadcasts, retailers have added the monitors and speakers to stations at the point of sale. In order to provide the wiring and power for the monitor and speakers, retailers have used existing conduits and wiring for electronic equipment at the point of sale to provide the wiring for monitors and speakers. This presents many problems. The first and biggest problem is that in order to repair or upgrade the monitors and speakers, all of the electronic components at the retail station must be shut down. All of the components must be shut down in order to work with the wiring for the monitor and speakers. This may cause a loss of sales while the station is not operational.

One particular example of a retail store that may provide broadcast programming at a point of sale is a gasoline station. A typical gasoline station includes a retail store and at least one island of gasoline pumps outside the store. For purposes of this discussion, a gasoline station is any retail outlet that sells gasoline for automobiles outside of the retail store. These may include grocery stores, convenience stores, hardware/ home improvement stores, and conventional gasoline stations. In a typical gasoline station, a monitor and connected speakers are installed in each pump. For purposes of this discussion, a fuel pump includes the pump and the housing that contains the pump and dispenses the fuel. One skilled in the art will also recognize that although a gasoline station is discussed, stations providing other types of fuel including, but not limited, electricity, hydrogen and other petroleum products. Wiring for the monitor and audio speakers are routed through a conduit from the retail store to the pump. The wiring connects the monitor and speakers to a control unit in the store. The control unit is then connected to an antenna in the store that receives signals for the broadcast displays from a network control system that is remote from the retail store. In order to work on the monitor or audio speakers, the fuel pump must be taken out of service.

A further problem with this type of configuration is that in order to provide the broadcast to all consumers a monitor must be mounted to each fuel pump. To allow all users to see the display, a display must be mounted on each side of the dispenser. This adds to the expense of the system since a monitor and speakers are needed for each pump. Furthermore, the sound from the different speakers may cause audio problems due to delays and other broadcast problems. Thus, those skilled in the art of installing such systems desire a system that eliminates the need to have wiring through a conduit for a fuel pump.

Solution

The above and other problems are solved and an advance in the art is made by a display system for a retail store made in accordance with this invention. A first advantage of this invention is that wiring for the display system is separate from wiring for retail stations. This allows the systems to be worked upon independently from one another. A second advantage is that monitors and speakers may be placed anywhere without regard to the placement of retail stations. This allows the least amount of monitors and speakers to be used in order to provide the broadcast to the greatest number of consumers.

In accordance with this invention, the system provides broadcast displays to a retail area outside a retail store. The system includes an antenna, a control unit, and a display. The display is communicatively connected to the control unit via a communications path that is external to a conduit connecting a retail station to control systems inside the retail store. The antenna receives signals, such as RF signals, transmitted from a network control unit. The received signals are then transmitted to the control unit. The control unit receives the signals and generates display signals from the signals. The display signals are then transmitted to the display that generates a display from the display signals. The display may be a monitor and audio speakers. In one embodiment of this invention the retail store is a gasoline station and the retail station is a fuel pump.

In some embodiments in accordance with this invention, the antenna may be located in various locations. In one embodiment, the antenna may be proximate the retail area. This means that the antenna is placed in any location close to the retail area that is suitable for location of the antenna in order to receive signals. In a second embodiment, the antenna may be atop a canopy covering said retail area.

The display may be mounted in various positions in accordance with this invention. In one embodiment, the display may be placed on a column between retail stations. In another embodiment, the display may be mounted to an under side of a canopy covering the retail area. In another embodiment, the display is mounted in a position that allows consumers from more than one retail area to view the display. In other embodiments, the display is mounted in a manner that the display may be viewed from angles of no more than one hundred and twenty degrees. In still another embodiment, the display may be mounted at position that is substantially perpendicular to a line of site between a consumer and the retail station.

In some embodiments, a retail interface may be mounted proximate or within the retail station. The retail interface receives purchase information, such as credit/debit card information from a user. A second communications path communicatively connects the retail interface to the control unit. The control unit then can be used to transmit said purchase information via the antenna to the network control unit. The network control unit may then authorize the transaction and transmit the approval back to the control unit of the system.

In accordance with this invention, the communications path between the display and the control unit may include a power line for providing power to the display. The control unit may then include an uninterruptible power supply that provides power to the display. The control unit may also activate or deactivate a display by providing power or by transmitting signals to the display.

In a preferred embodiment, the control unit is a computer system or other processing unit. The control unit receives signals from said antenna and converts the signals to display signals. The control unit may determine whether the signals include an address of the control unit and only convert the signals to display signals responsive to a determination that the address of the control unit is included in the signals. The converted display signal may be stored in a memory for later use. The control unit may then transmit the display signals to the display at a specified time. The control unit may also activate and deactivate said display at specified times. In other preferred embodiments, the control unit may include a circuit breaker connected to a power supply of the display.

In some embodiments, the system may include a distribution amplifier in the control unit. This may allow a plurality of displays to be affixed proximate to retail stations in an area to be connected to the control unit via communication paths external to paths connecting the retail stations to systems inside the retail store. The distribution amplifier generates display signals for each of the plurality of displays. The display signals may include video signals and audio signals.

In a preferred exemplary embodiment the distribution amplifier is a twisted pair distribution amplifier. In order to receive signals from the distribution amplifier, each display includes a twisted pair receiver in this exemplary embodiment. In this embodiment, each display also includes a monitor and an audio speaker. The twisted pair receiver splits the display signals into audio and video signals. The audio signals are then transmitted to the audio speakers and video signals are transmitted to the monitor.

In accordance with this invention, the system may also include a network control unit that is remote from the retail store. The network control unit transmits the signals received by the antenna. In preferred embodiments, the network control unit is a computer system or other processing unit. The network control unit executes instructions that generate the signals and transmit the signals. The generation of the signals may include inserting an address of the control unit to receive the signals. Preferably, this address in an Internet Protocol (IP) address.

### BRIEF DESCRIPTION OF THE DRAWINGS

The above and other features and aspects of this invention are described in the description given below and the following drawings:

FIG. 1 illustrating a prior art system for providing displays at a service station;

FIG. 2 illustrating a system for providing displays at a gasoline station in a preferred exemplary embodiment of this invention;

FIG. 3 illustrating a system for providing displays at a gasoline station in accordance with a second exemplary embodiment of this invention;

FIG. 4 illustrating a system for providing displays at a “drive-thru” area of a fast food restaurant in accordance with a third exemplary embodiment in accordance with this invention;

FIG. 5 illustrating a view of a display mounted on a column in accordance with this invention;

FIG. 6 illustrating components of a control unit in accordance with this invention;

FIG. 7 illustrating a processing system in the control unit in accordance with this invention;

FIG. 8 illustrating a network control unit in accordance with this invention; and

FIG. 9 illustrating a top view of a display mounted on a support column proximate a fuel pump.

### DETAILED DESCRIPTION

The following description of exemplary embodiments of this invention is not intended to limit the scope of the invention to these embodiments, but rather to enable any person skilled in the art to make and use the claimed invention.

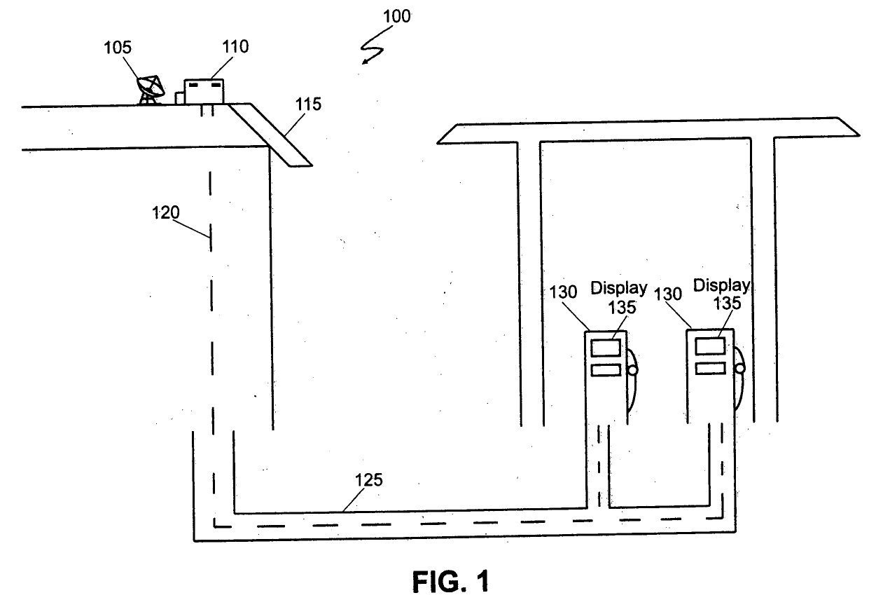

FIG. 1 illustrates a prior art system 100 for providing broadcast displays in a retail area outside of a retail store. For purposes of this discussion, the following definitions are used. A retail store is a building or other structure enclosing a primary retail area that houses the primary electronic systems for providing a retail sales. Examples of retail stores include, but are not limited to a convenience store at a gasoline station, a fast food restaurant, a hardware store and a home improvement store. A retail area outside of the retail store is an area that may be open or partially enclosed outside the store enclosure where products are sold. Examples of retail areas include, but are not limited to an island of fuel pumps at a gasoline station, a “drive thru” at a fast food restaurant, and a gardening area at a hardware or home improvement store. A retail station is a point of sale in the retail area outside the retail store. Examples of retail stations include, but are not limited to, a fuel pump in an island, a menu/speaker system in a “drive thru”, and a cash register in a gardening center.

Prior art system 100 includes display 135 in each fuel pump 130. The display may include a monitor and audio speakers. The displays are connected to a control unit 110 via communications path 120. One skilled in the art will recognize that communications path 120 may include one or more wires for providing video data to a monitor and audio data to audio speakers. Communications path 120 is included in a conduit 125 connecting fuel pumps to systems in retail store 115. Control unit 110 is either inside or proximate store 115. Control unit 110 is connected to antenna 105. Antenna 105 receives signals from a network control unit (not shown). The signals include broadcast data including video and audio data. Control unit 110 receives the signals and extracts the video and audio data from the received signals and transmits the video and audio data to display 135 via communications path 120. The problem with this configuration is that any repairs to a display 135 requires that fuel pump 130 be shut down.

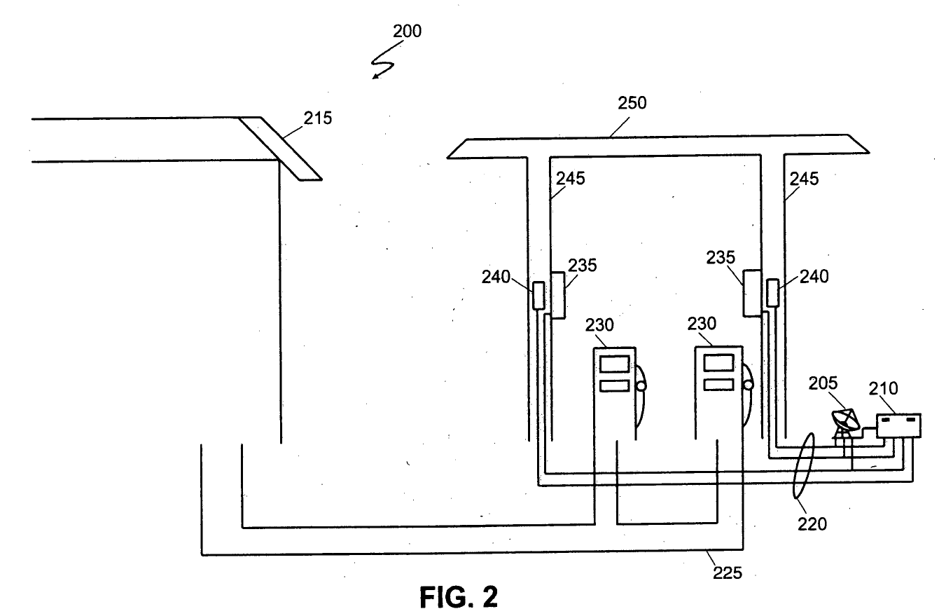

FIG. 2 illustrates a first exemplary embodiment of this invention. One skilled in the art will recognize that any combination of configurations of the various exemplary embodiments may be used to provide a system in accordance with this invention. In system 200, control unit 210 and antenna 205 are located proximate the fuel pump island and remote from store 215. This allows communication path 220 connecting displays 235 to control unit 220 to be external to the communication path 225, i.e. wiring, connecting fuel pumps 230 to systems inside retail store 215. Furthermore, the wiring for power of displays 235 may be separate power supply from fuel pumps 230. Thus, fuel pumps 230 do not have to be shut down in order to work on system 200.

Control unit 210 is preferably housed in an enclosure that is weather proof and tamper resistant. This may be a plastic enclosure or an enclosure made of another weather resistant material. The housing preferably includes an opening that prevents leakage of moisture into the container. The opening allows access to the components of control unit 210.

Furthermore, display 235 does not have to be placed inside of fuel pump 235. In this embodiment, displays 235 are mounted on support columns 245 of a canopy 250 over the fuel pump island. One skilled in the art will recognize that this also allows the number of displays to be reduced as users on both sides of a fuel pump 230 may view one display.

This embodiment may also have a retail interface 240 connected to the control unit 210 via a communications path 220. The retail interface 240 is a credit card reader that receives payment information and transmits payment information to control unit 210. Control unit 210 then communicates with an authorization system (not shown) via antenna 205 to receive authorization of the transaction.

Retail interface 240 may also be a system that reads a “club card” of a consumer to provide the consumer coupons or other offers from a retail outlet maintaining the “club card.” Alternatively, the retail interface may be an RF device that communicates with a PDA or other device via RF signals. Interface 240 may then receive or transmit advertisements and promotions to the consumer device.

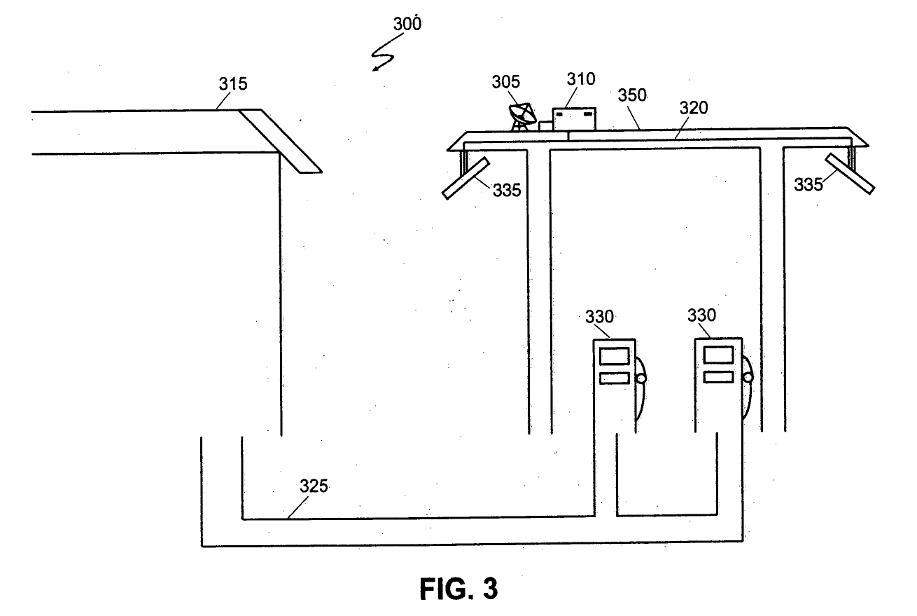

FIG. 3 illustrates a second exemplary embodiment of this invention. In system 300, antenna 305 and control unit 310 are mounted atop canopy 350 covering the fuel pump island that includes fuel pumps 330. In this embodiment, displays 335 are mounted to an under side of canopy 350 at angles allowing viewers on either side of fuel pumps 330. Displays 335 are connected to control unit 310 via communications paths 320. One of ordinary skill in the art can set the angles and exact positions of displays 335 under canopy 350 in a manner to be viewable by the greatest number of viewers. Communications paths 320 are external to conduit 325 connecting fuel pumps 330 to systems inside retail store 315.

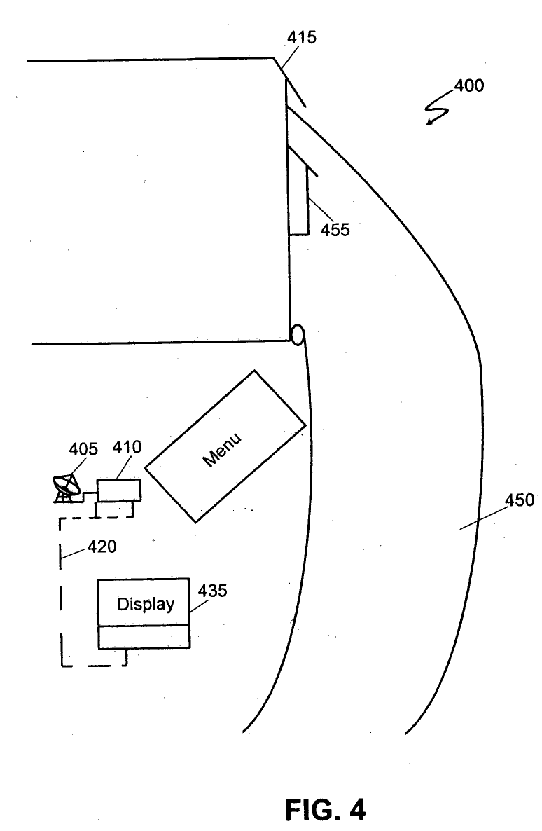

FIG. 4 illustrates another exemplary embodiment of this invention. In system 400, the display is provided along path 450 for a drive through window of restaurant 415. Display 435 is located proximate a menu and intercom system used for receiving orders from a driver. Preferably, display 435 is angled with respect to path 450 to allow at least one driver in an automobile in line along path 450 to view the display. Display 435 is connected to control unit 410 via communications path 420. Control unit 410 is then connected to antenna 405. Control unit 410 and antenna 405 may be placed anywhere within reasonable proximity to display 410 that facilitates easy access to control unit 410 and easy connection to display 435. One skilled in the art will recognize that although one display is shown in FIG. 4 any number of displays may be placed along path 450.

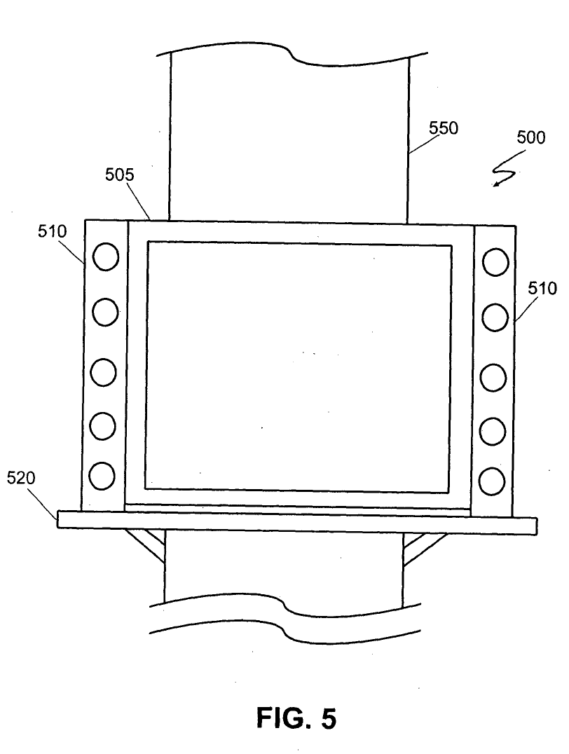

FIG. 5 illustrates a preferred display 500 mounted to a support column 550. Display 500 includes a monitor 505 and audio speakers 510. A mounting brace 520 is affixed to at least an underside of display 500 or may be connected to a backside of display 500.

Monitor 505 is preferably placed in a manner that it may be easily seen from an angle of at one hundred and twenty degrees from the plane of the viewing surface. Monitor 505 is also preferably a Liquid Crystal Display (LCD) panel incorporating amorphous silicon Thin Film Transistor (TFT) and backlight. A screen faceplate of monitor 505 includes an anti-glare polycarbonate. The faceplate may also be hardened and scratch resistant.

Monitor 505 also preferably has a 15-inch diagonal size for viewing of the image at a distance of 3 to 10 feet. Monitor 305 should also have a 30 ms response time to prevent image ghosting or other distortions.

Display 500 may also include a receiver for separating video and audio data. The video data is then transmitted from the receiver to monitor 505 and the audio data is transmitted from the receiver to the audio speakers. Preferably, the receiver is a twisted pair receiver to operate in conjunction with a twisted pair distribution amplifier in the control unit.

FIG. 9 illustrates a top view of a monitor 902 affixed to a support column 905 that is proximate a fuel pump 910. As can be seen from FIG. 9, users 915 and 920 on opposing sides of fuel pump 910 have a viewing angle or line of sight that substantially perpendicular or ninety degrees from the display surface of the monitor 902. Preferably, monitor 902 is mounted in a position that allows a person that has a line of sight that is substantially one hundred and twenty degrees with respect to the viewing surface to view the monitor. One skilled in the art will recognize that the height and angle of the mounted monitor 902 may be changed and still comply with these line of sight preferences.

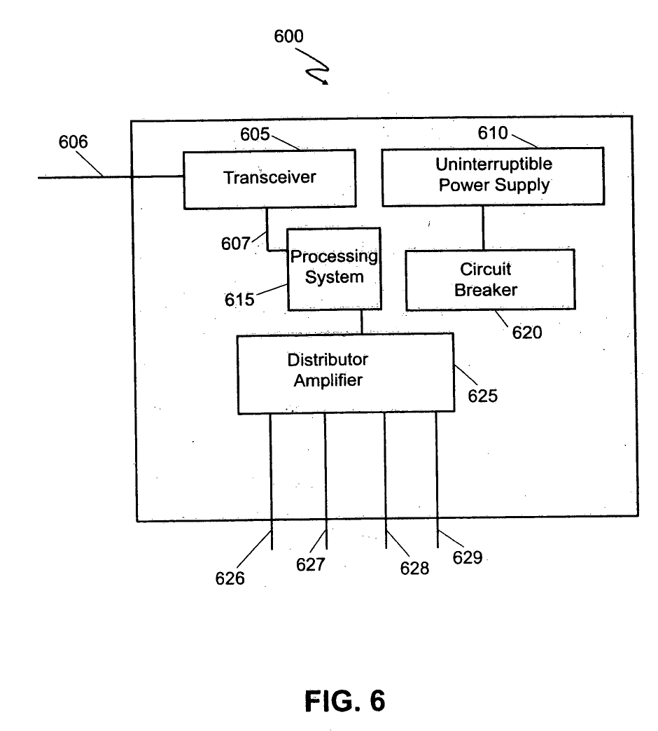

FIG. 6 illustrates a block diagram of components in a preferred control unit 600. Control unit 600 includes a transceiver 605 connected to an antenna via path 606. Transceiver 605 converts signals received from antenna into signals readable by processing system 615 and converts signals from processing system 615 into transmission signals. Transceiver 605 connects to processing system 615 via path 607.

Processing system 615 is computer or other processing device that executes instructions to provide the applications of control unit 600. A complete description of the components of processing system 615 is given below. Processing system 615 receives signals from the antenna and generates display signals. The display signals may include video and/or audio data. The display data may then be directly transmitted to displays or stored for later transmission to the display at a specified time. Processing system 615 may also activate and/or deactivate at specified times. Processing system 615 may also look for an address in the signals received from the antenna to determine whether the signals are intended for processing system 615. Preferably, the address is a MAC address that is commonly used in network communications.

Control unit 600 also includes an uninterruptible power supply 610. uninterruptible power supply 610 provides power to control unit 600 and the display even during a loss of power received from a connected power supply (not shown). Preferably, control unit 610 is connected to a standard 110-volt alternating current system that is incorporated into the outdoor retail area. Circuit breakers 620 provide power to the displays and prevent power to display during a short or while the display is being repaired or otherwise modified.

Distribution amplifier 625 receives display signals from processing system 615 and splits the signals from transmission to multiple display. The split display signals are then transmitted to the displays via paths 626-629. In a preferred embodiment, distribution amplifier 625 is a twisted pair distribution amplifier that provides video and audio signals to each of the displays.

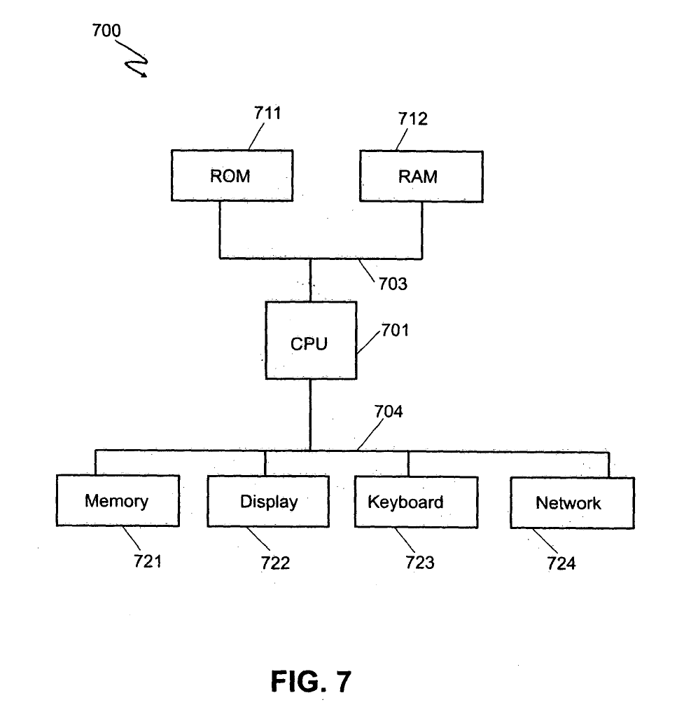

FIG. 7 illustrates an exemplary embodiment of a processing system 700 that may be used in processing system 615 of FIG. 6. However, the exact configuration and devices connected to a processing system 615 may vary.

Processing system 700 has a Central Processing Unit (CPU) 701. CPU 701 is a processor, microprocessor, or any combination of processors and microprocessor that execute instructions stored in memory to perform an application. CPU 701 is connected to a memory bus 703 and Input/Output (I/O) bus 704.

A non-volatile memory such as Read Only Memory (ROM) 711 is connected to CPU 701 via memory bus 703. ROM 711 stores instructions for initialization and other systems command of processing system 700. One skilled in the art will recognize that any memory that cannot be written to by CPU 701 may be used for the functions of ROM 711.

A volatile memory such as Random Access Memory (RAM) 712 is also connected to CPU 701 via memory bus 704. RAM 712 stores instructions for all processes being executed and data operated upon by the executed processes. One skilled in the art will recognize that other types of memories such as DRAM and SRAM may also be used as a volatile memory and that memory caches and other memory device (not shown) may be connected to memory bus 704.

Peripheral devices include, but not limited to, memory 721, display 722, I/O device 723, and network connection device 724 that are connected to CPU 701 via I/O bus 704. I/O bus 704 carries data between the device and CPU 701. Memory 701 is a device for storing data unto a media. Some examples of memory 721 include read/write compact discs (CDs), and magnetic disk drives. Display 722 is a monitor or display and associated drivers that convert data to a display. I/O device 723 is a keyboard, a pointing device or other device that may be used by a user to input data. Network device 724 is a modem or Ethernet “card” that connects processing system 700 to a network. In a processing system 615 network device 724 may be the transceiver 605 shown in FIG. 6. One skilled in the art will recognize that exact configuration and devices connected to each processing system may vary depending upon the operations that the processing system performs in the network.

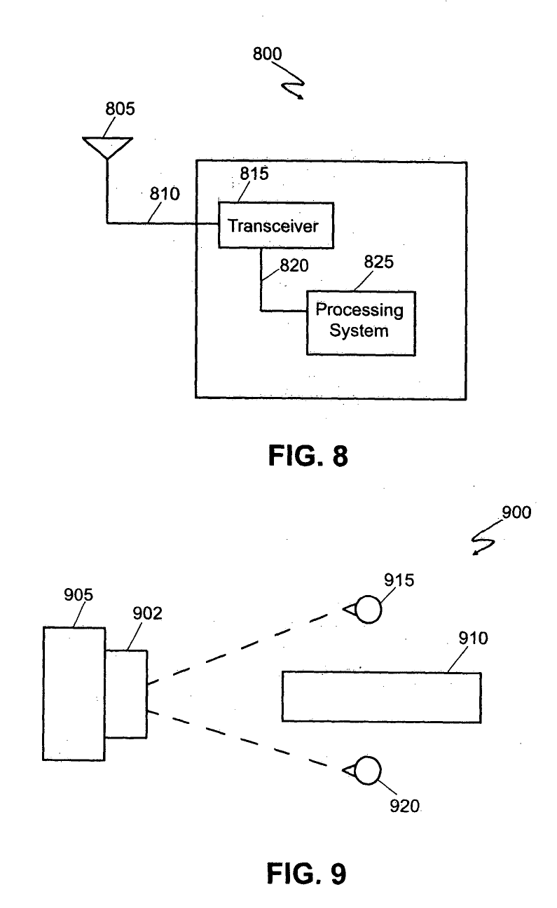

FIG. 8 illustrates a network control system 800 that transmits the signals to a system in accordance with this invention. Network control unit 800 includes an antenna 805 that transmits signals. Antenna 805 is connected to transceiver 815 via path 810. Transceiver 815 converts signals received via antenna 805 into signals readable by processing system 825 and signal from processing system 825 into signals transmittable by antenna 805.

Processing system 825 is a computer or other processing system that executes instructions to provide the applications of processing system 825. This application includes generating display signals, verifying payments, and including addresses of control units into transmissions. Processing system 825 is a processing system, an example of which is given in FIG. 7.

The above teaches exemplary embodiments of this invention. It is envisioned that those skilled in the art can and will build alternative systems that infringe on this invention as set forth below either literally or through the Doctrine of Equivalents.

What is claimed is:

1. A system for providing displays to consumers in an outdoor retail area of a retail store comprising:
an antenna for receiving signals;
a control unit communicatively coupled to said antenna to receive said signals and to generate display signals from said signals;
a display mounted proximate a retail station that receives said signals from said control unit and provides a display to consumers; and
a display communications path that communicatively couples said display to said control unit wherein said display communications path is external to a retail communications path connecting said retail station to said retail store.

2. The system of claim 1 wherein said retail store is a gasoline station and said retail station is a fuel pump.

3. The system of claim 1 wherein said antenna is proximate said outdoor retail area.

4. The system of claim 1 wherein said antenna is mounted atop a canopy covering said outdoor retail area.

5. The system of claim 1 further comprising:
a retail interface mounted proximate said retail station for receiving purchase information from a user; and
a second communications path communicatively connecting said retail interface to said control unit, wherein said control unit transmits said retail information via said antenna.

6. The system of claim 1 wherein said display is mounted in a position that is substantially perpendicular to a line of sight of a consumer using said retail station.

7. The system of claim 1 wherein said display mounted in a position that allows a consumer to view said display from a line of sight that has a range of substantially ninety degrees with respect to a surface of said display twenty degrees to substantially one hundred and twenty degrees with respect to a surface of said display.

8. The system of claim 1 further comprising:
a power line in said communications path for providing power from said control unit to said display.

9. The system of claim 1 further comprising:
an uninterruptible power supply in said control unit that provides power to said display and said control unit.

10. The system of claim 1 further comprising:
a distribution amplifier in said control unit.

11. The system of claim 10 further comprising:
a plurality of displays including said display, wherein each of said plurality of displays is affixed proximate one of a plurality of retail stations; and
a plurality of display communications paths including said display communications path, wherein each of said plurality of display communications paths connects a one of said plurality of displays to said control unit.

12. The system of claim 11 wherein said distribution amplifier generates display signals for each of said plurality of displays.

13. The system of claim 12 wherein said display signals include video signals and audio signals.

14. The system of claim 13 wherein said distribution amplifier is a twisted pair distribution amplifier.

15. The system of claim 14 wherein each of said plurality of displays comprise:
a twisted pair receiver.

16. The system of claim 15 wherein each of said plurality of displays further comprise:
a monitor; and
an audio speaker.

17. The system of claim 16 wherein said twisted pair receiver splits said display signals into audio and video signals, transmits said audio signals to said audio speaker, and transmits said video signals to said monitor.

18. The system of claim 1 wherein said control unit further comprises:
a processing unit;
instructions for directing said processing unit to:
receive signals from said antenna; and
convert said signals to display signals; and
a media readable by said processing unit that stores said instructions.

19. The system of claim 18 wherein said instructions further comprise:
instructions for directing said processing unit to:
determine whether said signals include an address of said control, and
converting said signals to display signals responsive to a determination that said address of said control unit is included in said signals.

20. The system of claim 18 wherein said instructions further comprise:
instructions for directing said processing unit to:
store said display signals in a memory connected to said processing unit.

21. The system of claim 20 wherein said instructions further comprise:
instructions for directing said processing unit to:
transmit said display signals to said display at a specified time.

22. The system of claim 18 wherein said instructions further comprise:
instructions for directing said processing unit to:
activate and deactivate said display at specified times.

23. The system of claim 1 wherein said control comprises:
a circuit breaker connected to a power supply of said display.

24. The system of claim 1 further comprising:
a network control unit remote from said gasoline station that transmits said signals received by said antenna.

25. The system of claim 24 wherein said network control unit comprises:
a processing unit;
instructions for directing said processing unit to:
transmit said signals; and
a media readable by said processing unit that stores said instructions.

26. The system of claim 25 wherein said instructions further comprising:
instructions for directing said processing unit to:
insert an address of said control unit into said signals.

27. The system of claim 26 wherein said address is an Internet Protocol address.

28. The system of claim 25 wherein said instructions further comprise:
instructions for directing said processing unit to:
generate said signals from broadcast content.

29. The system of claim 28 wherein said instructions further comprise:
instructions for directing said processing unit to:
insert timing and slot information for signals from said broadcast content.

30. The system of claim 1 further comprising:
a plurality of displays including said display, wherein each of said plurality of displays is affixed proximate one of a plurality of retail stations; and
a plurality of display communications paths including said display communications path, wherein each of said plurality of display communications paths connects a one of said plurality of displays to said control unit and is external to said retail communications paths connecting said plurality of retail stations to said retail store.

31. The system of claim 30 wherein said display signals include video signals and audio signals.

32. The system of claim 31 wherein each of said plurality of displays further comprise:
a monitor; and
an audio speaker.

33. The system of claim 32 wherein said display receiver splits said display signals into audio and video signals, transmits said audio signals to said audio speaker, and transmits said video signals to said monitor.

34. A method for providing displays to consumers in an outdoor retail area of a retail store comprising:
providing an antenna for receiving signals;
providing a control unit connected to communicatively coupled to said antenna to receive said signals and to generate display signals from said signals;
mounting a display proximate a retail station that receives said signals from said control unit and provides a display to consumers; and
communicatively coupling said display to said control unit via a display communications path wherein said display communications path is external to a retail communications path connecting said retail station to said retail store.

35. The method of claim 34 wherein said retail store is a gasoline station and said retail station is a fuel pump.

36. The method of claim 34 wherein said antenna is proximate said outdoor retail area.

37. The method of claim 34 further comprising:
mounting said antenna atop a canopy covering said outdoor retail area.

38. The method of claim 34 further comprising:
mounting a retail interface proximate said retail station for receiving purchase information from a user; and
communicatively connecting said retail interface to said control unit, via a second communications path external to said retail communications path wherein said control unit transmits said retail information via said antenna.

39. The method of claim 34 further comprising:
mounting said display in a position that is approximately perpendicular to a line of sight of a consumer using said retail station.

40. The method of claim 34 further comprising:
mounting said display in a position that allows a consumer to view said display from a line of sight that has a range of substantially ninety degrees with respect to a surface of said display twenty degrees to substantially one hundred and twenty degrees with respect to a surface of said display.

41. The method of claim 34 further comprising:
providing power from said control unit to said display via a power line in said communications.

42. The method of claim 34 further comprising:
providing an uninterruptible power supply in said control unit that provides power to said display and said control unit.

43. The method of claim 34 further comprising:
providing a distribution amplifier in said control unit.

44. The method of claim 43 further comprising:
affixing each of a plurality of displays including said display proximate to one of a plurality of retail stations; and
communicatively coupling each of said plurality of display to said control unit via a one of a plurality of display communications paths including said display communications path, wherein each of said plurality of display communications paths connects a one of said plurality of displays to said control unit and is external to said retail communications path.

45. The method of claim 44 further comprising:
generating display signals for each of said plurality of displays in said distribution amplifier.

46. The method of claim 45 wherein said display signals include video signals and audio signals.

47. The method of claim 45 wherein said distribution amplifier is a twisted pair distribution amplifier.

48. The method of claim 47 further comprising:
providing a twisted pair receiver in each of said plurality displays.

49. The method of claim 48 wherein said step of mounting each of said plurality of displays further comprises:
mounting a monitor for each of said plurality of display proximate said one of said plurality of retail stations; and
mounting an audio speaker for each of said plurality of display proximate said one of said plurality of receivers.

50. The method of claim 49 further comprising:
splitting said display signals into audio and video signals with said receiver;
transmitting said audio signals to said audio speaker; and
transmitting said video signals to said monitor.

51. The method of claim 38 further comprising:
receiving signals from said antenna in said control unit; and
converting said signals to display signals in said control unit.

52. The method of claim 51 wherein said instructions further comprising:
determining whether said signals include an address of said control, and
converting said signals to display signals responsive to a determination that said address of said control unit is included in said signals.

53. The method of claim 51 further comprising:
storing said display signals in a memory connected to said control unit.

54. The method of claim 53 further comprising:
transmitting said display signals from said control unit to said display at a specified time.

55. The method of claim 51 further comprising:
activating and deactivating said display at specified times with said control unit.

56. The method of claim 34 further comprising:
connecting a circuit breaker between a power supply and said display.

57. The method of claim 34 further comprising:
transmitting said signals from a network control unit remote from said retail store to said antenna.

58. The system of claim 57 further comprising:
inserting an address of said control unit into said signals in said network control unit.

59. The method of claim 58 wherein said address is an Internet Protocol address.

60. The method of claim 59 further comprising:
generating said signals from broadcast content in said network control unit.

61. The method of claim 60 further comprising:
inserting timing and slot information into signals from said broadcast content in said network control unit.

62. The method of claim 34 further comprising:
affixing each of a plurality of displays including said display, proximate one of a plurality of retail stations; and
communicatively coupling each of said plurality of displays to said control unit via a one of a plurality of display communications paths including said display communications path, wherein each of said plurality of display communications paths connects a one of said plurality of displays to said control unit and is external to said retail communications paths connecting said plurality of retail stations to said retail store.

63. The method of claim 62 wherein said display signals include video signals and audio signals.

64. The method of claim 63 wherein the step of affixing each of said plurality of displays further comprise:
mounting a monitor proximate one of said plurality of retail stations; and
mounting an audio speaker proximate said one of said plurality of retail stations.

65. The method of claim 64 wherein said display receiver splits said display signals into audio and video signals, transmits said audio signals to said audio speaker, and transmits said video signals to said monitor.

66. A system for providing electronic displays in an outdoor fueling area of a retail store comprising:
a display affixed to a support proximate a fuel pump; and
a control unit communicatively coupled to said display that provides display signals to said display.
